(19) United States
(12) Patent Application Publication
(10) Pub. No.: US 2015/0122804 A1
(43) Pub. Date: May 7, 2015

(54) SPLATTER AND SPLASH GUARD TO MORE UNIFORMLY HEAT ITEMS IN MICROWAVE OVENS AND METHOD THEREFOR

(71) Applicants: TRIEU TRUONG, PRESCOTT VALLEY, AZ (US); TONY TRUONG, PRESCOTT VALLEY, AZ (US); THIEN TRUONG, PRESCOTT VALLEY, AZ (US)

(72) Inventors: TRIEU TRUONG, PRESCOTT VALLEY, AZ (US); TONY TRUONG, PRESCOTT VALLEY, AZ (US); THIEN TRUONG, PRESCOTT VALLEY, AZ (US)

(21) Appl. No.: 14/335,701

(22) Filed: Jul. 18, 2014

Related U.S. Application Data
(60) Provisional application No. 61/900,965, filed on Nov. 6, 2013.

(51) Int. Cl. H05B 6/64

(52) U.S. Cl. CPC H05B 6/6408; H05B 6/6402
USPC 219/732; 219/734; 219/756

(57) ABSTRACT

A splatter guard for a microwave oven has a container. The container has an open bottom surface and an opening formed on a side area of the container.

### RELATED APPLICATIONS

This patent application is related to U.S. Provisional Application No. 61/900,965, filed Nov. 6, 2013, entitled “SPLATTER AND SPLASH GUARD FOR USE WITH MICROWAVE OVENS” in the name of the same inventors stated above, and which is incorporated herein by reference in its entirety. The present patent application claims the benefit under 35 U.S.C §119(e).

### TECHNICAL FIELD

The present application relates generally to accessories for a microwave oven, and more specifically, to a splatter guard that helps to prevent food and liquids from splattering onto the walls of the microwave oven and which will help retain heat emitted from said foods and liquids within its walls and heat the items within the splatter guard faster and more uniformly.

### BACKGROUND

Microwave ovens (hereinafter microwaves) have revolutionized food preparation since being invented in the 1940's and introduced for home use back in the 1960's. Microwaves are now commonly used in almost every household for the purposes of but not limited to heating, cooking, and defrosting foods, liquids, and/or other items (hereinafter food). Microwaves are generally used for time efficiency rather than for cooking quality, both in commercial applications, such as restaurants and offices, and at home.

Microwaves cook by sending electromagnetic radiation in the microwave spectrum through the food placed within the microwave. The electromagnetic radiation causes polarized molecules in the food to rotate and build up thermal energy in a process known as dielectric heating. Depending on water content, food composition and the frequency of the radiation, electromagnetic radiation deposit initially heat more deeply than other cooking methods.

As the rapid heat accumulation occurs, the food placed within the microwave oftentimes may create heat bubbles that lead to splashes within the microwave. If not contained, the splashes end up on the interior walls of the microwave and can be difficult to clean. The splattering within the microwave is very undesirable. People will oftentimes cover their food with plastic wrap or paper towels to prevent the splattering from happening. If not covered, the food that splatters oftentimes forms around the inside of the microwave and is very difficult to clean and remove. If left for long periods, the foods can eventually stain the inside of the microwave and leave permanent marks.

Previous inventions have tried to address this phenomenon in different ways. For example, disposable guards have been made that cover the plates or bowls where the foods sit in the microwave. There have been adjustable guards that are adjustable and cover the tops of specifically made heating containers. There have also been containers and lids that have been created for specific use within the microwave.

Each of the above mentioned related art works to resolve the problem of containing splatters within the microwave. However, they all have certain issues associated with them. For example, many of the above prior art devices are mostly removable and most often have to be used in conjunction with the foods where they either touch the food or need to be washed each time something is heated within the microwave. Covers that touch the heated items at times can be undesirable because of health risks associated to plastic contamination into the heated items. Further, most all of the prior art devices fully cover the food item. If the heated items are fully covered, they may lead to the accumulation of steam within the closed housing and can become a source of dangerous steam burns to the user. While some of these devices may have ventilation holes, the ventilation holes only allow a small amount of the steam to escape. Thus, steam may still accumulate in these devices and may lead to dangerous steam burns to the user. Also, steam is not always something that is desired when using a microwave. Some foods change in composition because of the steam and don't taste as they are intended. For instance breads get soggy.

An additional issue with microwaves is the uneven heating of the food items. The uneven distribution of the microwave energy within the microwave may result in uneven distribution of heat through the food placed within the microwave to be heated. This uneven distribution is a result of standing wave patterns set up in the oven enclosure which sustain minimum and maximum points of field intensity which cause the portions of the body in the more intense field regions to be heated more than the portions of the body in the minimum field intensity regions.

In the past, to obtain or produce a more even distribution of the microwave energy within the microwave, devices such as rotating fan blades or reflectors, have been employed to aid in the diffusion of the microwave energy throughout the interior of the microwave. Other devices and methods to more evenly heat the food items may include placing the food to be heated upon rotating tables which, in theory, would revolve the food through the maximum and minimum areas of energy distribution, thereby providing for even heating throughout.

Therefore, it would be desirable to provide a device and method that overcomes all of the above. The device and method would warm/heat the food and or liquids within the microwave evenly, while helping to contain the splatters. The device and method may have the ability to remain in the microwave and only be removed to clean or else be built directly into the microwave itself. The device and method also does not need to be touched when inserting and removing food.

### SUMMARY

This summary is provided to introduce a selection of concepts in a simplified form that are further described below in the DESCRIPTION OF THE APPLICATION. This summary is not intended to identify key features of the claimed subject matter, nor is it intended to be used as an aid in determining the scope of the claimed subject matter

In accordance with one embodiment, a splatter guard for a microwave oven is disclosed. The splatter guard has a container. The container has an open bottom surface and an opening formed on a side area of the container.

In accordance with another embodiment, a splatter guard for a microwave oven is disclosed. The splatter guard has a container. The container has an open bottom surface and an open front surface.

In accordance with another embodiment, a splatter guard for a microwave oven is disclosed. The splatter has a container, wherein the container has an open bottom surface and an open side surface. A plurality of leg members are attached to the container. The plurality of leg members raises the container to form gaps between the container and a surface upon which the container is positioned upon. The container has a pair of side surfaces. A rear surface is attached to and continuous from the pair of side surfaces. A top surface is attached to and continuous from the pair of side surfaces and the rear surface. The open side surface is formed on a front side area of the container. The pair of side surfaces and rear surface are angled inward to form a rectangular trapezoid.

### BRIEF DESCRIPTION OF DRAWINGS

The novel features believed to be characteristic of the application are set forth in the appended claims. In the descriptions that follow, like parts are marked throughout the specification and drawings with the same numerals, respectively. The drawing figures are not necessarily drawn to scale and certain figures can be shown in exaggerated or generalized form in the interest of clarity and conciseness. The application itself, however, as well as a preferred mode of use, further objectives and advantages thereof, will be best understood by reference to the following detailed description of illustrative embodiments when read in conjunction with the accompanying drawings, wherein:

FIG. 1 is a perspective view of a splatter and splash guard of the present invention positioned in an interior of a microwave oven;

FIG. 2 is a side view of the splatter and splash guard of the present invention removed from the interior of a microwave oven;

FIG. 3 is a front view of the splatter and splash guard of the present invention removed from the interior of a microwave oven;

FIG. 4 is a rear view of the splatter and splash guard of the present invention removed from the interior of a microwave oven;

FIG. 5 is a top view of the splatter and splash guard of the present invention removed from the interior of a microwave oven; and

FIG. 6 is a bottom view of the splatter and splash guard of the present invention removed from the interior of a microwave oven.

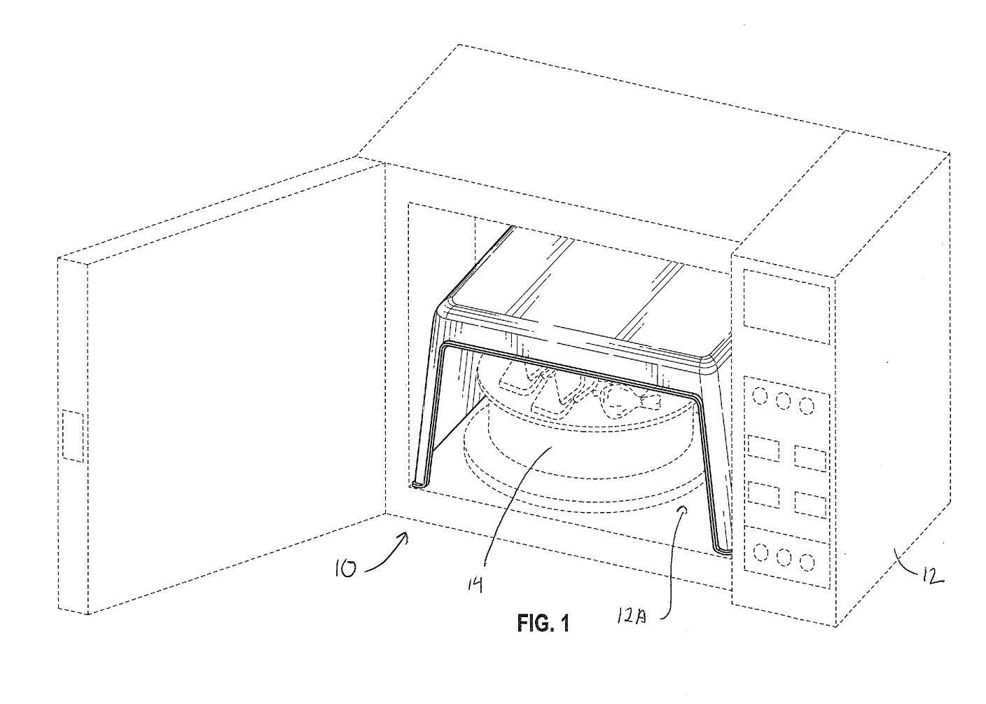

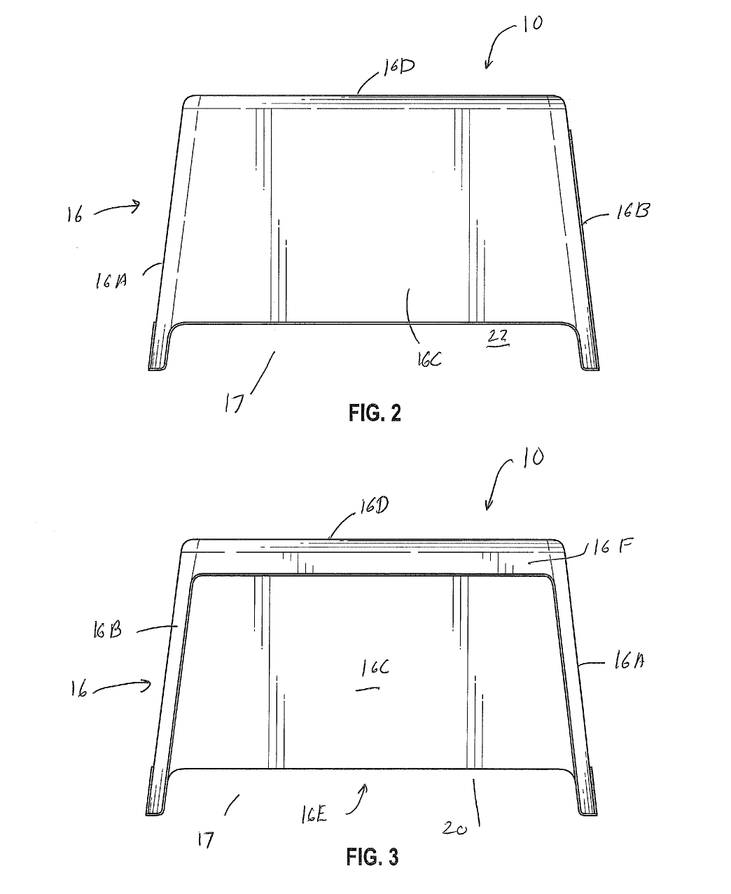

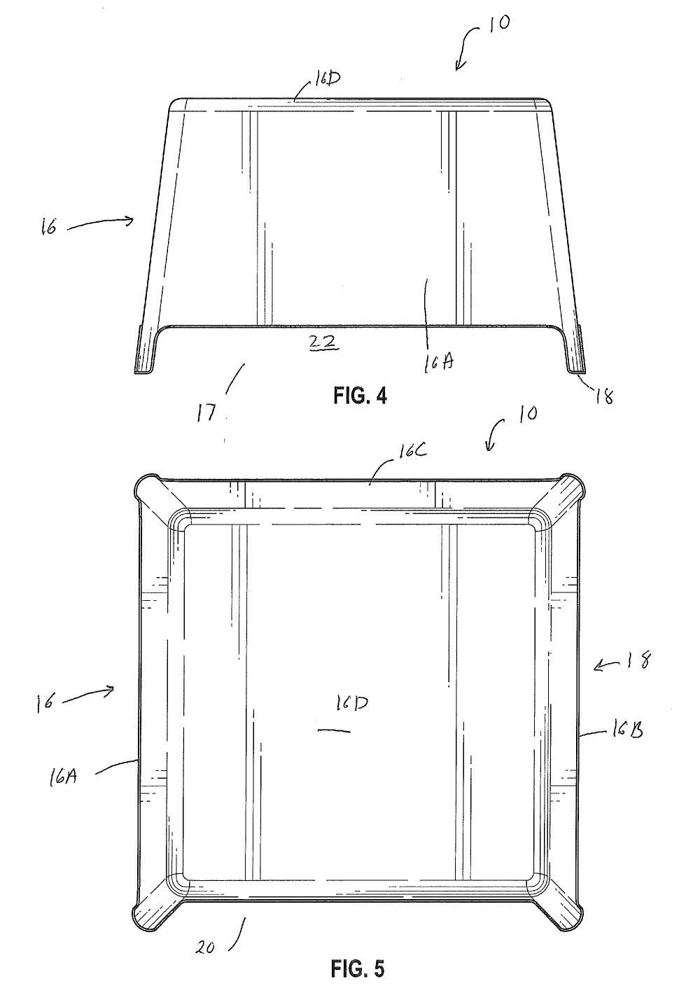

### DESCRIPTION OF THE APPLICATION

The description set forth below in connection with the appended drawings is intended as a description of presently preferred embodiments of the application and is not intended to represent the only forms in which the present application can be constructed and/or utilized. The description sets forth the functions and the sequence of steps for constructing and operating the application in connection with the illustrated embodiments. It is to be understood, however, that the same or equivalent functions and sequences can be accomplished by different embodiments that are also intended to be encompassed within the spirit and scope of this application.

Referring now to the Figures, a splatter and splash guard 10 (Hereinafter guard 10) may be seen. The guard 10 may be positioned in an interior 12A of a microwave oven 12 (hereinafter microwave 12). The guard 10 may be removable so that the guard 10 may be taken out of the microwave 12 for cleaning. Alternatively, the guard 10 may be affixed within the microwave 12. The guard 10 may be used for several purposes. The guard 10 may be used to prevent the food, beverages, or other items 14 (hereinafter food 14) placed within the microwave 12 from splattering and sticking on to the interior 12A of the microwave 12. The guard 10 may be used to more evenly heat the food 14 placed in the interior 12A of the microwave oven 12.

The guard 10 may be formed of a cover 16 having an open bottom 17 and an open side 20. The cover 16 may be formed of different geometrical configurations. The cover 16 may be circular, square, rectangular, trapezoidal, or the like. The above listing is given as an example and should not be seen in a limiting manner. The cover 16 may be formed of other geometrical configurations without departing from the sprit and scope.

In the present embodiment, the cover 16 may have a pair of side surfaces 16A and 16B. The side surfaces 16A and 16B may be angled inward. In accordance to one embodiment, the pair of side surfaces 16A and 16B both angled inwardly at approximately the same angle.

A rear surface 16C may be attached to and may be continuous from the side surfaces 16A. The rear surface 16C may be angled inwards. In accordance to one embodiment, the pair of side surfaces 16A and 16B and the rear surface are all angled inwardly at approximately the same angle to form a rectangular trapezoid.

A top surface 16D may be attached to and continuous from the pair of side surfaces 16A and 16B and the rear surface 16C.

The cover 16 may have an open end 16E. In the present embodiment, the open end 16E is positioned to face the door of the microwave 12. This configuration allows for one to easily insert the food 14 into the interior 12A of the microwave 12 and under the cover 16. The top surface 16D may extend slightly down towards the open end 16E. The top surface 16D may thus form a lip member 16F which extends down towards the open end 16E.

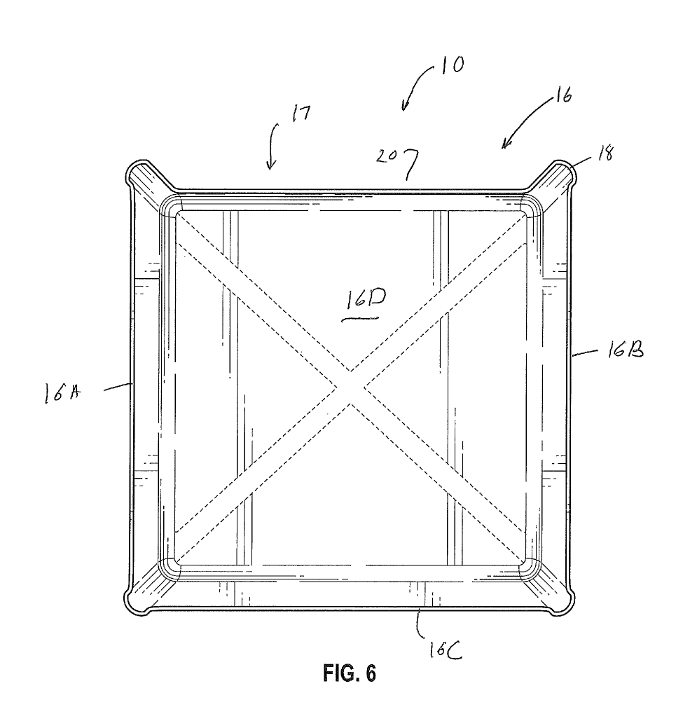

The cover 16 may have a plurality of leg members 18. A leg member 18 may extend down from each corner of the cover 16. The leg members 18 may lift the cover 16 above the floor 12B in the interior 12A of the microwave 12. The leg members 18 thus form openings 22 at a bottom surface of the side surfaces 16A and 16B and the rear surface 16C. The leg members 18 may be integral to and extend down from the corners of the cover 16. As shown more clearly in FIG. 6, the leg members 18 have a curvature.

The leg members 18 and the openings 22 at the bottom surface of the side surfaces 16A and 16B and the rear surface 16C, may allow the cover 10 to be positioned in a microwave 12 and to allow for a revolving glass tray in the microwave 12 to fit underneath the cover 10 and still rotate.

The cover 16 may be used to prevent food positioned under the cover 16 from splattering and sticking to the interior 12A of the microwave 12. The cover 16 prevents the accumulation of steam within the cover 16. The open end 16E and the openings 20 of the cover may be used to allow steam to escape from within the cover 16. Thus, the cover 16 may be used to prevent dangerous steam burns to the user. The cover 16 may be used to more evenly heat the food 14. The open end 16E and the openings 20 in the cover 16 may allow for the more evenly distributing microwave energy within the microwave 12, thereby resulting in more even heating and cooking of food 14 prepared in the oven.

The guard 10 of the present invention may be formed of any type of material that is deemed safe to use in the microwave. For example, the guard 10 may be formed of microwave safe plastic, such as polypropylene, or the like. Other materials such as glass may be used. The above listing is given as an example and should not be seen in a limiting manner. Any type of microwave safe material may be used without departing from the spirit and scope of the present invention.

While embodiments of the disclosure have been described in terms of various specific embodiments, those skilled in the art will recognize that the embodiments of the disclosure may be practiced with modifications within the spirit and scope of the claims.

What is claimed is:

1. A splatter guard for a microwave oven comprising:
a container;
wherein the container has an open bottom surface and an opening formed on a side area of the container.

2. The splatter guard of claim 1, wherein the splatter guard further comprises a plurality of leg members attached to the container, wherein the plurality of leg members raises the container to form gaps between the container and a surface upon which the container is positioned upon.

3. The splatter guard of claim 1, wherein the container comprises:
a pair of side surfaces;
a rear surface attached to and continuous from the pair of side surfaces;
a top surface attached to and continuous from the pair of side surfaces and the rear surface;
wherein the opening is formed on a front side area of the container.

4. The splatter guard of claim 3, wherein the pair of side surfaces and rear surface are angled inward to form a rectangular trapezoid, the opening formed on a front side area of the rectangular trapezoid.

5. The splatter guard of claim 3, wherein the splatter guard further comprises a plurality of leg members, wherein the plurality of leg members raises the container to form gaps between each of the pair of side surfaces and a surface upon which the container is positioned upon and the rear surface and the surface upon which the container is positioned upon.

6. The splatter guard of claim 5, wherein an individual leg member is positioned at intersections between each side surface and the rear surface and between each side surface and the opening formed on the front side area of the container.

7. The shoe insert of claim 1, wherein the container is built into the microwave.

8. The shoe insert of claim 1, wherein the container is removable from the microwave.

9. A splatter guard for a microwave oven comprising:
a container;
wherein the container has an open bottom surface and an open front surface.

10. The splatter guard of claim 9, wherein the splatter guard further comprises a plurality of leg members attached to the container, wherein the plurality of leg members raises the container to form gaps between the container and a surface upon which the container is positioned upon.

11. The splatter guard of claim 9, wherein the container comprises:
a pair of side surfaces;
a rear surface attached to and continuous from the pair of side surfaces; and
a top surface attached to and continuous from the pair of side surfaces and the rear surface;
wherein the open front surface is configured to allow one to place items underneath the cover.

12. The splatter guard of claim 11, wherein the pair of side surfaces and rear surface are angled inward to form a rectangular trapezoid.

13. The splatter guard of claim 11, wherein the splatter guard further comprises a plurality of leg members, wherein the plurality of leg members raises the container to form gaps between each of the pair of side surfaces and a surface upon which the container is positioned upon and the rear surface and the surface upon which the container is positioned upon.

14. The shoe insert of claim 11, wherein the container is built into the microwave.

15. The shoe insert of claim 11, wherein the container is removable from the microwave.

16. A splatter guard for a microwave oven comprising:
a container, wherein the container has an open bottom surface and an open side surface; and
a plurality of leg members, wherein the plurality of leg members raises the container to form gaps between the container and a surface upon which the container is positioned upon
wherein the container comprises:
a pair of side surfaces;
a rear surface attached to and continuous from the pair of side surfaces; and
a top surface attached to and continuous from the pair of side surfaces and the rear surface;
wherein the open side surface is formed on a front side area of the container;
wherein the pair of side surfaces and rear surface are angled inward to form a rectangular trapezoid.

17. The splatter guard of claim 16, wherein an individual leg member is positioned at intersections between each side surface and the rear surface and between each side surface and the opening formed on the front side area of the container.

18. The shoe insert of claim 16, wherein the container is built into the microwave.

19. The shoe insert of claim 16, wherein the container is removable from the microwave.
